(19) United States
(12) Patent Application Publication
(10) Pub. No.: US 2006/0211963 A1
(43) Pub. Date: Sep. 21, 2006

(54) Device for washing and creating massaging vibrations within a bar of soap

(75) Inventors: John Wilford Spirk, Gates Mills, OH (US); John Richard Nottingham, Bratenahl, OH (US); Jay Tapper, Shaker Heights, OH (US); Carolyn Marie McNeeley, Brunswick Hills, OH (US); Patrick William Brown, Auburn, OH (US); Charles Peter Althoff, Cleveland Heights, OH (US)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Conopco, Inc., d/b/a UNILEVER

(21) Appl. No.: 11/372,879

(22) Filed: Mar. 10, 2006

Related U.S. Application Data
(60) Provisional application No. 60/662,259, filed on Mar. 16, 2005.

(51) Int. Cl. A61H 19/00

(52) U.S. Cl. 601/93

(57) ABSTRACT

A hand-held massaging device for use with an associated soap bar includes a housing having a portion that is removably attached to the associated soap bar and an agitating assembly secured to the housing. The agitating assembly includes a motor and an agitating member operatively attached to the motor. The agitating member and the motor cooperate to transmit vibrations from the housing to the associated soap bar. In another embodiment, the hand-held massaging device includes a housing having an upper and a lower portion, the upper portion being rotatably mounted to the lower portion, the lower portion being removably attached to the associated soap bar, and an oscillating assembly secured to the housing. The oscillating assembly includes a motor and an oscillating member operatively attached to the motor. The oscillating member and the motor cooperate to impart an oscillatory motion to the associated bar soap relative to the upper portion of the housing.

A claim for domestic priority is made herein under 35 U.S.C. §119(e) to Provisional App. Ser. No. 60/662,259 filed on Mar. 16, 2005.

### BACKGROUND

The invention relates generally to bar soap devices that impart massaging vibrations and oscillations to a user of the device while washing, scrubbing, or bathing. Various bathing devices are known employing techniques that facilitate washing and scrubbing. Some of these devices also use small electric motors to transmit vibrations throughout a bar of soap. However, several deficiencies exist with the prior art devices.

One deficiency involves the failure of these devices to provide for a quick and convenient replacement of a used or expired bar of soap. Some devices include a vibrating or agitating assembly that are permanently embedded into the soap. In these devices, once the existing bar of soap is consumed, the vibrating or agitating assembly can not be reused with a new bar of soap. This not only increases costs to the consumer of such devices but also is less environmentally conscious due to the additional waste produced by discarding a used or expired device. Furthermore, these devices do not permit a user to selectively choose and attach different soaps in the event the user prefers a soap having a different scent, consistency, or texture.

Another deficiency exists in the technique employed in transmitting vibration and or oscillations to the bar of soap. Prior art devices primarily use an off-centered or eccentric weight to produce a vibration in the bar soap. This technique is less favored in that the vibrations are not as effective in producing a massaging effect. An eccentric weight transmits various amplitudes of vibrations in a 360 degree plane making it difficult for the user to direct or focus the vibration into a tissue area requiring massaging and relaxing vibrations.

Accordingly, it has been considered desirable to develop a new and improved hand-held massaging bar soap device which would overcome the foregoing difficulties and others while providing better and more advantageous overall results.

### SUMMARY OF THE INVENTION

In one embodiment, a hand-held massaging device for use with an associated soap bar includes a housing having a portion that is removably attached to the associated soap bar and an agitating assembly secured to the housing. The agitating assembly includes a motor and an agitating member operatively attached to the motor. The agitating member and the motor cooperate to transmit vibrations from the housing to the associated soap bar.

In another embodiment, the hand-held massaging device includes a housing having an upper and a lower portion. The upper portion is rotatably mounted to the lower portion and the lower portion is removably attached to the associated soap bar. The hand-held massaging device further includes an oscillating assembly secured to the housing. The oscillating assembly includes a motor and an oscillating member operatively attached to the motor. The oscillating member and the motor cooperate to impart an oscillatory motion to the associated bar soap relative to the upper portion of the housing.

In yet another embodiment, a housing of a hand-held massaging device includes a handle.

In yet another embodiment, an agitating assembly of a hand-held massaging device includes a scotch-yoke assembly for generating vibrations.

In yet another embodiment, an agitating assembly of a hand-held massaging device includes a dual opposed cam disc assembly for generating vibrations.

In yet another embodiment, an agitating assembly of a hand-held massaging device includes an eccentric weight agitating member.

In yet another embodiment, an agitating assembly of a hand-held massaging device includes a vibrating motor for generating vibrations.

In yet another embodiment, an agitating assembly of a hand-held massaging device includes a plurality of vibrating motors disposed circumferentially within a housing.

In yet another embodiment, an agitating assembly of a hand-held massaging device includes a solenoid having a translating shaft for generating vibrations.

### BRIEF DESCRIPTION OF THE DRAWINGS

The invention may take form in certain structures and components, several embodiments of which will be described in detail in this specification and illustrated in the accompanying drawings. In the drawings:

FIG. 1A is an assembled front perspective view of a first embodiment of a massaging bar soap according to the present invention.

FIG. 1B is an exploded perspective view of the massaging bar soap of FIG. 1A, illustrating a housing and an insert of the massaging bar soap.

FIG. 1C is a cross sectional view of the massaging bar soap of FIG. 1A (along section lines 1C-1C), illustrating an agitating assembly and the engagement of an outer lip of the housing with an inner lip of the insert.

FIG. 1D is an enlarged cross sectional view of the massaging bar soap of FIG. 1C, illustrating the engagement of the outer lip of the housing with the inner lip of the insert.

FIG. 2A is an assembled front perspective view of a second embodiment of a massaging bar soap including a handle, according to the present invention.

FIG. 2B is an exploded perspective view of the massaging bar soap of FIG. 2A, illustrating a housing and an insert of the massaging bar soap.

FIG. 2C is a cross sectional view of the massaging bar soap of FIG. 2A (along section lines 2C-2C), illustrating an agitating assembly and the engagement of an outer lip of the housing with an inner lip of the insert.

FIG. 3A is an assembled front perspective view of a third embodiment of a power massaging bar soap, according to the present invention.

FIG. 3B is a top view of the massaging bar soap of FIG. 3A, illustrating the location of a motor and an oscillating member within a housing of the massaging bar soap.

FIG. 3C is a cross sectional view of the massaging bar soap of FIG. 3A, illustrating an oscillating assembly and the engagement of an outer lip of the housing with an inner lip of an insert.

FIG. 4A is an assembled front perspective view of a fourth embodiment of a massaging bar soap including a scotch-yoke agitating assembly, according to the present invention.

FIG. 4B is a cross sectional view of the massaging bar soap of FIG. 4A (along section lines 4B-4B), further illustrating the scotch-yoke agitating assembly.

FIG. 5A is an assembled front perspective view of a fifth embodiment of a massaging bar soap including a dual opposed cam disc agitating assembly, according to the present invention.

FIG. 5B is a cross sectional view of the massaging bar soap of FIG. 5A (along section lines 5B-5B), further illustrating the dual opposed cam disc agitating assembly.

FIG. 6A is an assembled front perspective view of a sixth embodiment of a massaging bar soap including a vibrating motor agitating assembly, according to the present invention.

FIG. 6B is a cross sectional view of the massaging bar soap of FIG. 6A (along section lines 6B-6B), further illustrating the vibrating motor agitating assembly.

FIG. 7A is an assembled front perspective view of a seventh embodiment of a massaging bar soap including multiple vibrating motors and an electronic controller as part of an agitating assembly, according to the present invention.

FIG. 7B is a cross sectional view of the massaging bar soap of FIG. 7A (along section lines 7B-7B), further illustrating the multiple vibrating motor agitating assembly.

FIG. 8A is an assembled front perspective view of an eighth embodiment of a massaging bar soap including a switch controlled solenoid motor agitating assembly, according to the present invention.

FIG. 8B is a cross sectional view of the massaging bar soap of FIG. 8A (along section lines 8B-8B), further illustrating the switch controlled solenoid motor agitating assembly.

FIG. 9A is an assembled front perspective view of a ninth embodiment of a massaging bar soap including an electronically controlled solenoid motor agitating assembly, according to the present invention.

FIG. 9B is a cross sectional view of the massaging bar soap of FIG. 9A (along section lines 9B-9B), further illustrating the electronically controlled solenoid motor agitating assembly.

### DETAILED DESCRIPTION

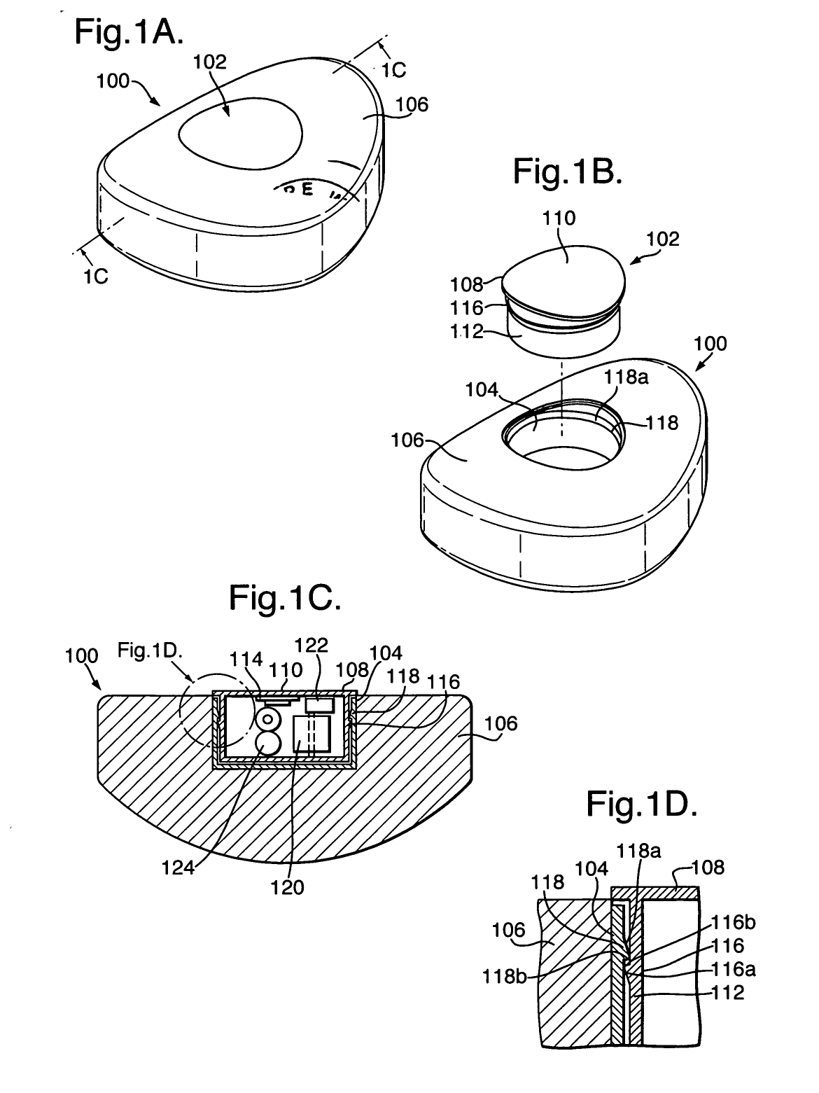

With reference to FIGS. 1A-1D, a first embodiment of a power massaging bar soap 100 is shown. The massaging bar soap 100 generally includes an agitating assembly 102, an insert or socket 104 and a solid bar of soap 106. With reference to FIGS. 1B-1 D, the agitating assembly 102 generally includes a housing 108 having an upper portion 110 and a lower portion 112. The upper portion 110 may include a switch 114 for powering the agitating assembly on and off. The switch 114 may be a pressure activated switch mounted below the upper portion 110 of the housing 108. The upper portion 110 may be constructed from a semi-flexible material such that by depressing the portion directly above the switch, the material will deform adequately so as to operate the switch 114. The lower portion 112 of the housing 108 may include a snappingly engageable outer lip or edge 116. The outer lip 116 may include a beveled surface 116a and a flat surface 116b. As shown in FIGS. 1B-1D, the outer lip 116 is disposed circumferentially about a lower portion 112 of the housing 108.

Also shown in FIGS. 1B-1D is the insert 104 disposed within the bar soap 106. The insert 104 includes a snappingly engageable inner lip 118 disposed along an inner circumferential surface of the insert 104. As with the outer lip 116, the inner lip 118 also includes a beveled surface 118a and a flat surface 118b. The primary difference between the outer lip 116 and the inner lip 118 is that the respective beveled surfaces 116a, 118a are complementary to one another such that as the agitating assembly 102 is inserted into the insert 104, the beveled surfaces 116a, 118a will substantially and uniformly be in contact. As the agitating assembly is urged into the insert 104, the outer lip 116 and the inner lip 118 deflect slightly in opposite radial directions to permit the outer lip 116 to move past the inner lip 118. As shown in FIG. 1D, once the outer lip 116 slides past the inner lip 118, the outer lip flat surface 116b and inner lip flat surface 118b remain substantially and uniformly in contact. Both the outer lip flat surface 116b and the inner lip flat surface 118b may be perpendicular to the outer surface of the lower portion 112 of the housing 108 and the inner surface of the insert 104. In this manner, the beveled surfaces and the flat surfaces of the outer lip and inner lip cooperate to lock the agitating assembly 102 and securely hold the housing 108 within the insert 104. Although the outer and inner lips interlock securely upon insertion of the housing 108 into the insert 104, the lips can be separated or pried apart by pulling the housing 108 and the insert 104 or soap 106 in opposite directions. This permits the user to change the soap to accommodate personal preferences as to the type, texture, scent, or consistency of different soaps. Furthermore, the user can easily dispose of only the insert once all of the soap has been used and replace the insert with a new bar.

Of course, the insert 104 may take on any shape, such as a round, oval or rectangular shape, so long as the overall shape of the insert 104 compliments the outer shape of the housing 108 of the agitating assembly 102. As shown in FIG. 1B, the insert 104 and the housing 108 are generally cylindrical in shape. Furthermore, the insert 104 is securely attached and disposed within the bar of soap 106. The insert 104 may be molded in during the soap casting process and placed within the soap 106 before the soap hardens into a solid bar.

With continued reference to FIG. 1C, a vertical cross section of the power massaging bar soap 100 is shown. Specifically, the internal components of the agitating assembly 102 are shown. Generally, the agitating assembly 102 includes a motor 120, an agitating member 122 and a power source 124. The power source 124 may include any type of portable electrical power, such as that provided by a battery. The switch 114 or other device may be used to activate the motor 120. In addition, the motor 120 is operatively connected to the agitating member 122. The agitating member may include a variety of standard components used to produce a vibration, either through a rotating unbalance or through the rapid acceleration and deceleration of a mass. Furthermore, the agitating member may include a type of chattering mechanism to rapidly accelerate and decelerate a mass against a fixed or solid surface. The motor 120 may be of any type of electromagnetic device that may impart a rotational input or a linear reciprocating motion to the agitating member 122. In addition, the placement and orientation of the motor and the agitating member may affect the overall directionality of the vibrations through the bar soap 106. In other words, depending on the orientation of the motor and the agitating member, the bar of soap 106 may tend to vibrate moreso in along a horizontal plane or in a plane normal to the horizontal plane.

Lastly, the power source 124 may include standard alkaline, nickel cadmium, lithium, nickel metal hydride or any other conventional type battery, either rechargeable or not. In addition, the housing 108 of the agitating assembly 102 may include recharging port or contacts for recharging the power source 124 of the agitating assembly 102. Also, rather than having a switch 114 to activate the motor and agitating member, a motion activated switch may be used, such that the massaging bar soap 100 automatically turns on upon being moved.

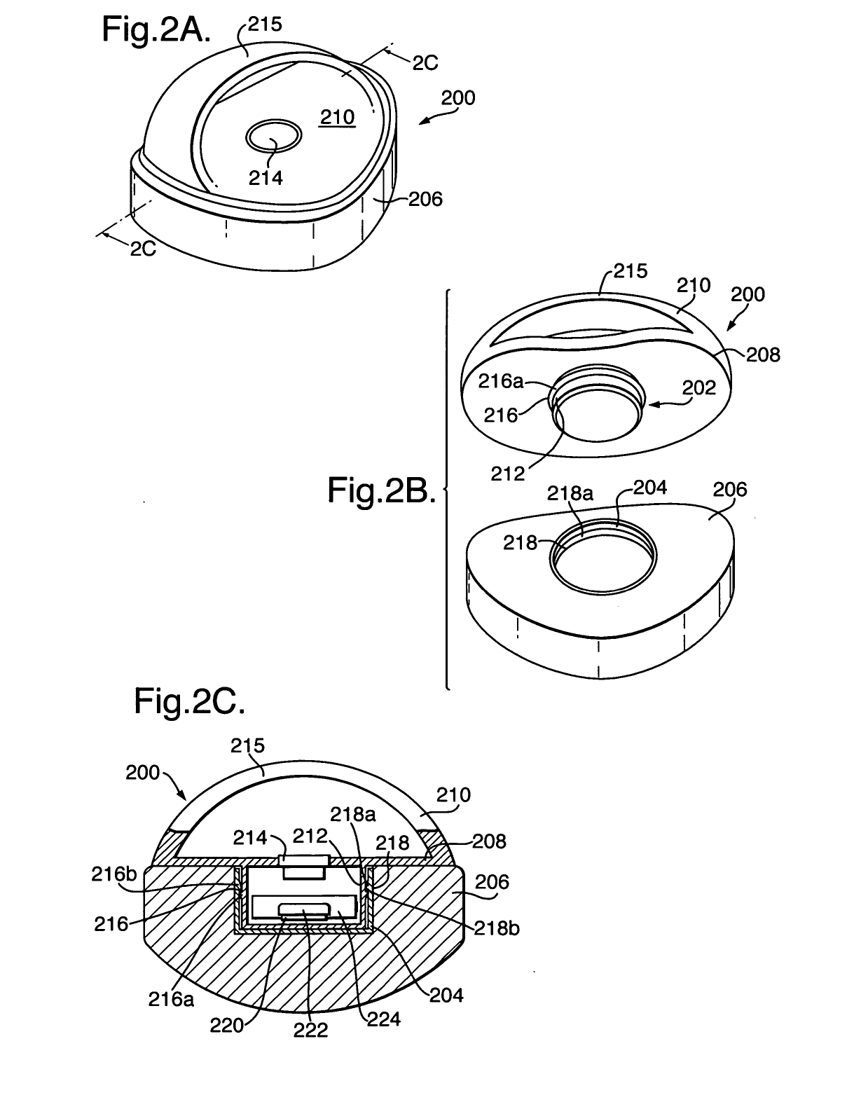

Now with reference to FIGS. 2A-2C, a second embodiment of a power massaging bar soap 200 is shown. The second embodiment involves many of the same features of the first embodiment. Generally, the second embodiment of the massaging bar soap 200 includes a removable agitating assembly 202, an insert 204 disposed within and securely attached to a solid bar of soap 206. As with the first embodiment, the agitating assembly 202 includes a housing 208 having an upper portion 210 and a lower portion 212. The upper portion 210 includes a switch 214 and a handle 215. The switch 214 may be located anywhere along the housing 208 and may be located along the upper portion 210 beneath the handle 215 in order to prevent inadvertent activation of the massaging bar soap 200. As with the first embodiment, the second embodiment includes a lower portion 212 having a circumferentially disposed outer lip 216. The lip 216 includes a beveled surface 216a and a flat surface 216b. Similarly, the insert 204 includes a circumferentially disposed inner lip 218. The inner lip also includes a beveled surface 218a and a flat surface 218b.

With continued reference to FIG. 2C, a cross section of the second embodiment of the power massaging bar soap 200 is shown. As illustrated, a motor 220, an agitating member 222 and a power source 224 are disposed internally to the housing 208 of the agitating assembly 202. As before, the motor 220, the agitating member 222 and the power source 224 cooperate to generate vibrations which are transmitted through the housing 208 and into the solid bar of soap 206. Here, the motor is of the integrated vibrating type similar to those used in pager and cellular phone devices. The vibrations provide a generally soothing and relaxing effect to the user of the massaging bar soap 200.

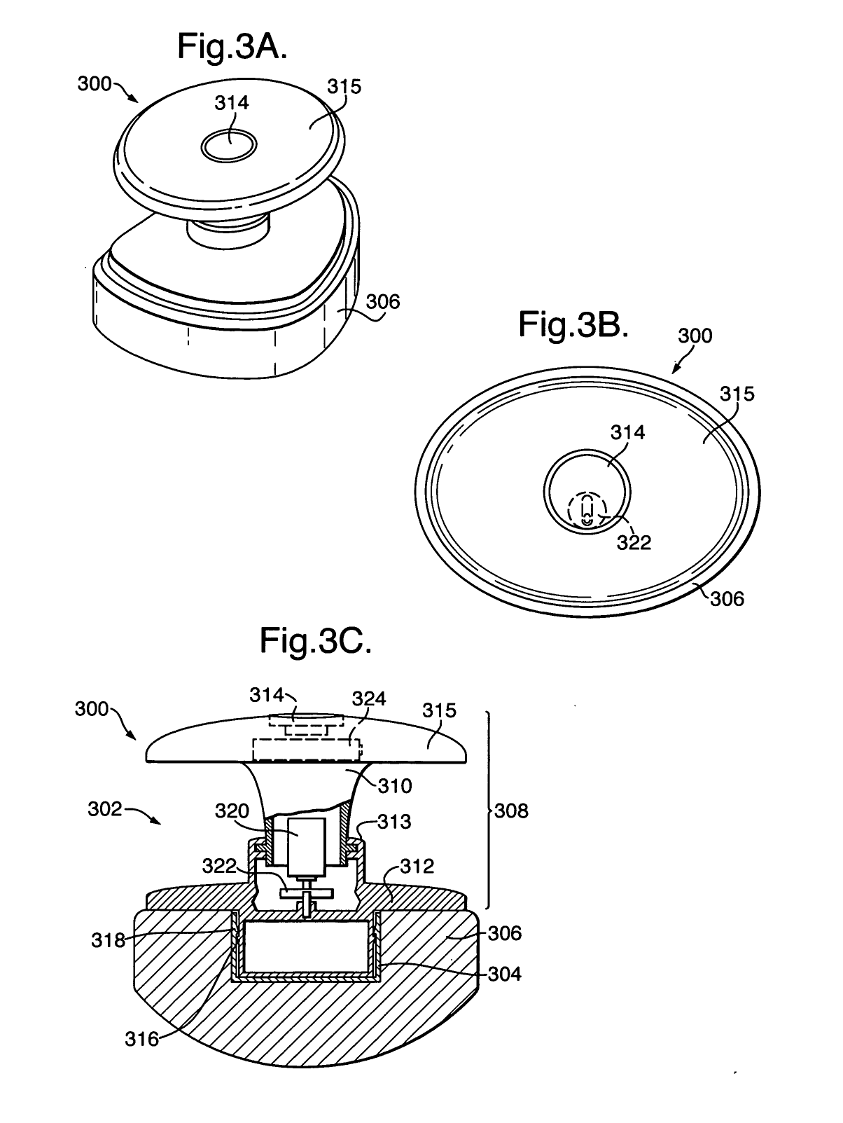

Now with reference to FIGS. 3A-3C, a third embodiment of a power massaging bar soap 300 is shown. As with the previous embodiments, the power massaging bar soap 300 includes many of the same features. However, the primary distinction with the third embodiment is that the massaging bar soap 300 produces an oscillating motion rather than a vibrating motion. Generally, the massaging bar soap 300 includes a reusable oscillating assembly 302, an insert or a socket 304 and a solid bar of soap 306. The oscillating assembly 302 includes a housing 308 having an upper portion 310 and a lower portion 312. Between the upper portion 310 and a lower portion 312 is a rotatable joint 313 which permits the upper portion 310 to rotate independently from the lower portion 312. The upper portion 310 also includes a switch 314. The upper portion 310 may be generally shaped to form a handle 315. It should be noted that it is entirely possible to include a vibrating or agitating assembly (in addition to the oscillating assembly) in the massaging bar soap 300 similar to any of the agitating assemblies described herein.

With particular reference to FIG. 3C, the lower portion 312 and the insert 304 are shown in greater detail. The insert and the lower portion 312 are snappingly engageable in a similar manner as shown with respect to the previous embodiments. As before, the lower portion 312 includes an outer lip 316 having a beveled surface and a flat surface. Similarly, the insert 304 includes an inner lip 318 circumferentially disposed within the insert 304 having a beveled surface and a flat surface. As discussed previously, the outer lip 316 and the inner lip 318 cooperate such that the bar of soap 306 becomes rigidly, yet removably, attached to the oscillating assembly 302 when the oscillating assembly 302 is urged into the insert or socket 304.

The oscillating assembly 302 further includes a motor 320, an oscillating member 322 and a power source 324. Generally, the motor 320 may be secured to the upper portion of the housing 108, whereas the oscillating member 322 may be operatively connected to the lower portion. In this manner, as the motor generates torque, the torque is transmitted via the oscillating member 322 to the lower portion of the housing 308. The oscillating member 322 may be of the scotch-yoke type as discussed and shown in more detail with reference to a fourth embodiment of the massaging bar soap. Generally, the scotch yoke oscillating member includes a disc having an off-center peg. The disc is operatively attached to the motor such that when the motor is activated the off-center peg rotates in a circular fashion. A complementary slot or groove in the lower portion 312 receives the peg and causes the lower portion 312 to rotate slightly in one direction and then to reverse direction and rotate slightly in the opposite direction. When operating, the user grips the handle 315 and a reaction force is created between the upper portion and the lower portion such that the lower portion turns while the handle 315 is held steady. Naturally, the orientation of the motor and oscillating member could be reversed to achieve the same oscillating effect between the upper and lower portions of the housing. As such, the oscillating motion generates a soothing, relaxing, deep tissue and therapeutic effect to a user of the massaging bar soap 300. In addition, the oscillating motion will help to produce soap lather during bathing.

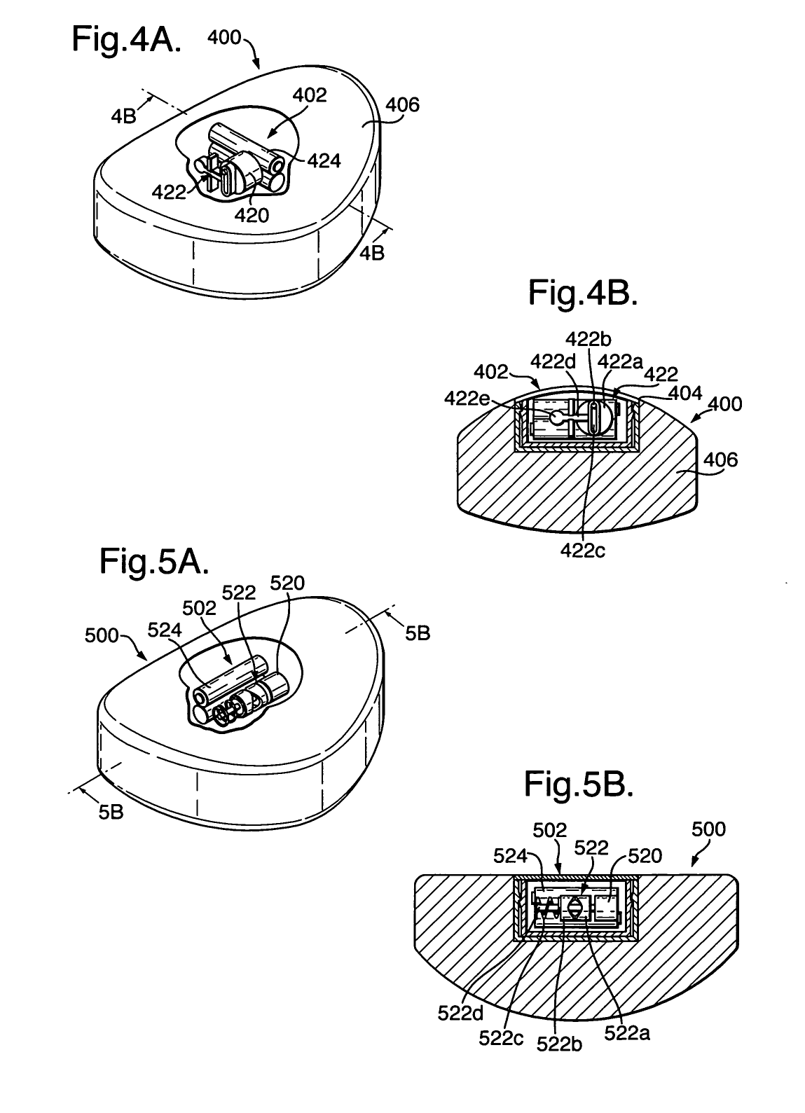

Now with reference to FIGS. 4A-9B, various alternate embodiments are shown for a massaging bar soap. Specifically with reference to FIGS. 4A and 4B, a fourth embodiment of a massaging bar soap 400 is shown. As with the previous embodiments, the fourth embodiment includes an agitating assembly 402, an insert or socket 404, and a solid bar of soap 406. Here, the agitating assembly 402 also includes a motor 420, an agitating member 422 and a power source 424. In addition, the agitating member 422 is of the scotch-yoke type. Generally, a scotch-yoke mechanism uses a rotating disc 422a having an off center projection 422b which is slideably engaged along an elongated slot 422c. As the motor 420 rotates the disc 422a, a rod member 422d having a weight at 422e attached to one end is urged in a reciprocating fashion causing the weight to accelerate and decelerate rapidly. The rapid acceleration and deceleration of the weight 422e produces vibrations within the agitating assembly 402 which are transmitted through the bar of soap 406.

With reference to FIGS. 5A and 5B, a fifth embodiment of a massaging bar soap 500 is shown. As before, the massaging bar soap 500 includes many of the same features of the previous embodiments. The primary distinction involves an agitating assembly 502. As before, the agitating assembly includes a motor 520, an agitating member 522 and a power source 524. The agitating member 522 involves a dual opposed cam disc assembly and includes a rotating cam disc 522a, a stationary cam disc 522b, a biasing member 522c and a shaft 522d. The rotating cam disc 522a includes a contact surface having a curved profile. Similarly, the stationary cam disc 522b also includes a contact surface having a curved profile. The stationary cam disc 522b is disposed about the shaft 522d and urged toward the rotating cam disc 522a by the biasing member 522c. In addition, the motor 522 is operatively connected to the rotating cam disc 522a. When the motor 520 is activated, the rotating cam disc 522a begins to rotate while remaining in sliding contact with the stationary cam disc 522b. Due to the cam profiles of each cam disc, a rapid transverse vibration occurs along the longitudinal direction of the motor shaft. Depending on the speed of the motor, a very rapid or high frequency type vibration can be achieved, thus producing a more relaxing or soothing type vibration for the user of the massaging bar soap 500.

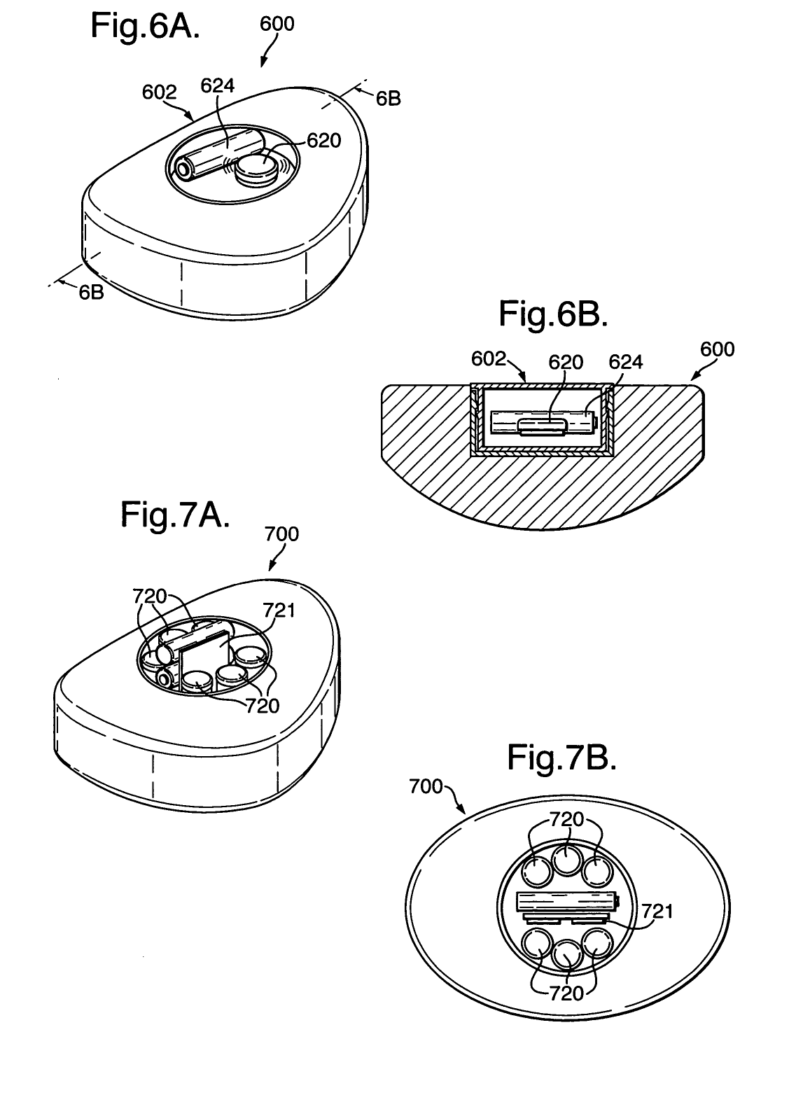

Now with reference to FIGS. 6A and 6B, a sixth embodiment of a massaging bar soap 600 is shown. The massaging bar soap 600 includes an agitating assembly 602 having a motor 620 and a power source 624. Here, the motor 620 is a self contained unit and of the standard or conventional type used in cell phones or pagers. With reference to FIGS. 7A and 7B, a seventh embodiment of a massaging bar soap 700 is shown. The massaging bar soap 700 is nearly identical to the sixth embodiment except for that a plurality of vibrating motors 720 are used in which are controlled by an electronic control board 721. The control board 721 may energize the vibrating motors 720 either independently, in series, in parallel, or in a random type configuration. Naturally, depending on which vibration mode is implemented, various types of vibrating effects may be achieved.

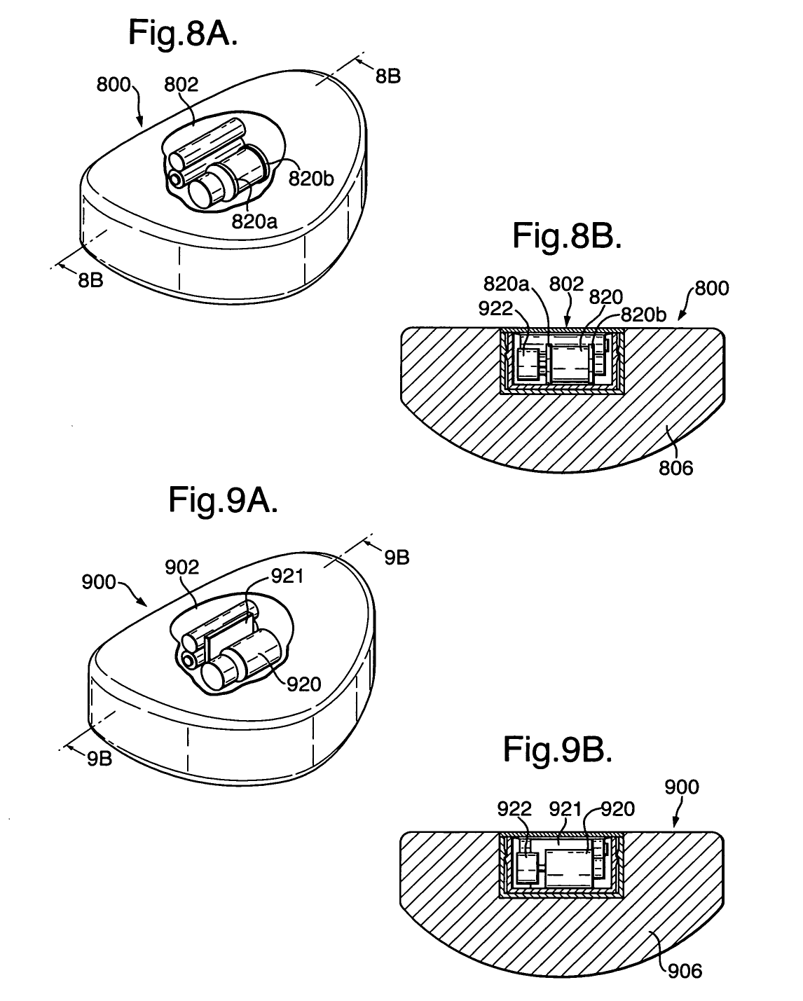

Now with reference to FIGS. 8A and 8B, an eighth embodiment of a massaging bar soap 800 is shown. Here, an agitating assembly 802 involves the use of a slightly different agitating member as compared to the previous embodiments. The agitating member employs the use of a weight 822 operatively connected to the shaft of a solenoid type motor 820. The solenoid motor 820 includes a first mechanical switch 820a and a second mechanical switch 820b. When the motor 820 is activated, the solenoid begins to urge the shaft causing it to translate in one direction until a first maximum position is reached. At this point either the first or the second mechanical switch 820a, 820b reverses the polarity of the solenoid. Upon reversing the polarity, the shaft is then urged in the opposite direction until a second maximum position is reached. Now, the other mechanical switch again reverses the polarity of the solenoid. This process occurs indefinitely and results in the rapid acceleration and deceleration of the weight 822 causing a vibration throughout the bar of soap 806.

A ninth embodiment of a massaging bar soap 900, as shown in FIGS. 9A and 9B, operates in a similar manner to the eighth embodiment of the massaging bar soap 800. The massaging bar soap 900 also includes an agitating assembly 902 having a solenoid type motor 920 and a weight 922. The agitating assembly 902 of the ninth embodiment differs in that it includes a control board 921 for operatively regulating the polarity of the solenoid motor 920. Ultimately, this effects the direction of travel of a shaft or plunger within the solenoid motor 920. The control board 921 may be programmed such that a variety of frequencies and wave forms can be reproduced by the solenoid motor 920. Thus the ninth embodiment is capable of producing a variety of vibrations throughout the bar of soap 906. It should be noted that the solenoid motors 920 may include a protruding shaft from both ends of the solenoid and have weights attached thereto. This would double the amount of vibrating mass and intensify the forces generated by the agitating assembly.

Modifications and alterations will occur to others upon reading and understanding the preceding detailed description. It is intended that the embodiments described herein be construed as including all such modifications and alterations, insofar as they come within the scope of the appended claims or the equivalents thereof.

1. A hand-held massaging device for use with an associated soap bar, comprising:
a housing having a portion that is removably attached to the associated soap bar;
an agitating assembly secured to the housing, the agitating assembly including a motor and an agitating member operatively attached to the motor;
wherein the agitating member and the motor cooperate to transmit vibrations from the housing to the associated soap bar.

2. The massaging device of claim 1, wherein a portion of the housing is snappingly received by an embedded insert in the associated soap bar.

3. The massaging device of claim 1, wherein the housing includes a handle.

4. The hand-held massaging device of claim 1, wherein the agitating assembly includes a scotch-yoke assembly.

5. The hand-held massaging device of claim 1, wherein the agitating assembly includes a dual opposed cam disc assembly.

6. The hand-held massaging device of claim 1, wherein the agitating member is an eccentric weight.

7. The hand-held massaging device of claim 1, wherein the motor of the agitating assembly is a vibrating motor.

8. The hand-held massaging device of claim 1, wherein the agitating assembly includes a plurality of vibrating motors disposed circumferentially within the housing.

9. The hand-held massaging device of claim 1, wherein the motor is a solenoid having a translating shaft, the shaft having a first maximum position and a second maximum position.

10. The hand-held massaging device of claim 9, wherein the agitating assembly further includes at least one switch disposed adjacent to the shaft for operatively controlling a direction of travel of the shaft between the first maximum position and the second maximum position.

11. The hand-held massaging device of claim 9, wherein the agitating assembly further includes an electronic controller for operatively controlling a direction of travel of the shaft between the first maximum position and the second maximum position.

12. A hand-held massaging device for use with an associated soap bar, comprising:
a housing having an upper and a lower portion, the upper portion being rotatably mounted to the lower portion, the lower portion being removably attached to the associated soap bar;
an oscillating assembly secured to the housing, the oscillating assembly including a motor and an oscillating member operatively attached to the motor;
wherein the oscillating member and the motor cooperate to impart an oscillatory motion to the associated bar soap relative to the upper portion of the housing.

13. The massaging device of claim 12, wherein the upper portion of the housing includes a handle.

14. The massaging device of claim 12, further comprising an agitating assembly secured to the housing, the agitating assembly including a motor and an agitating member operatively attached to the motor, wherein the agitating member and the motor cooperate to transmit vibrations from the housing to the associated soap bar.

15. The hand-held massaging device of claim 14, wherein the agitating assembly includes a scotch-yoke assembly.

16. The hand-held massaging device of claim 14, wherein the agitating assembly includes a dual opposed cam disc assembly.

17. The hand-held massaging device of claim 14, wherein the agitating member is an eccentric weight.

18. The hand-held massaging device of claim 14, wherein the motor of the agitating assembly is a vibrating motor.

19. The hand-held massaging device of claim 14, wherein the agitating assembly includes a plurality of vibrating motors disposed circumferentially within the housing.

20. The hand-held massaging device of claim 14, wherein the motor is a solenoid having a translating shaft, the shaft having a first maximum position and a second maximum position.

21. The hand-held massaging device of claim 20, wherein the agitating assembly further includes at least one switch disposed adjacent to the shaft for operatively controlling a direction of travel of the shaft between the first maximum position and the second maximum position.

22. The hand-held massaging device of claim 20, wherein the agitating assembly further includes an electronic controller for operatively controlling a direction of travel of the shaft between the first maximum position and the second maximum position.
